(19) United States
(12) Patent Application Publication
(10) Pub. No.: US 2025/0071373 A1
(43) Pub. Date: Feb. 27, 2025

(54) SYSTEMS AND TECHNIQUES FOR DISTRIBUTED CLOUD VIRTUAL MEMORY

(71) Applicant: LUMANA INC., Sunnyvale, CA (US)

(72) Inventors: Ofir MULLA, Talme Elazar (IL); Sagi BEN MOSHE, Ein Ayala (IL); Edan SORSKI, Tel Aviv (IL); Roy MICHAEL, Herzliya (IL); Aviad ZABATANI, Kfar Vitkin (IL); Ron KIMMEL, Haifa (IL); Oz DONNER, Beit Herut (IL); Yonatan Charls RESNIK, Kibuz HaHotrim (IL)

(73) Assignee: LUMANA INC., Sunnyvale, CA (US)

(21) Appl. No.: 18/452,719

(22) Filed: Aug. 21, 2023

(51) Int. Cl. H04N 21/44; H04N 21/266

(52) U.S. Cl. CPC H04N 21/44004; H04N 21/26606

(57) ABSTRACT

A system and method for data processing. A method includes sending, by a first system, a plurality of data processing requests to a buffer, wherein the buffer is stored in a second system, wherein the second system is remote from the first system; pulling a portion of the plurality of data processing requests from the buffer; processing the portion of the plurality of data processing requests pulled from the buffer in order to obtain at least one data processing result; and sending the at least one data processing result to the buffer.

### TECHNICAL FIELD

The present disclosure relates generally to cloud computing, and more specifically to distributed data storage and processing in hybrid cloud-edge environments.

### BACKGROUND

Cloud computing is the practice of using networks of remote servers, typically hosted via the Internet, in order to store, manage, and/or process data. Such networks hosting remote servers are generally referred to as cloud networks, or colloquially as “the cloud.” Cloud computing solutions offer an alternative to traditional computing on a local server or personal computer. Using remotely hosted systems allows consumers of cloud computing services to access computing resources without needing to directly manage those computing resources. This provides various benefits such as, for example, the ability to scale up processing and storage on demand, protection provided by cybersecurity tools deployed in the cloud, ongoing maintenance which may be provided by third parties, and more.

Some data processing systems offload at least part of their processing to cloud resources. Using resources deployed in the cloud in order to process data improves access to processing and storage resources, but presents tradeoffs with respect to speed and latency. That is, processing data in the cloud typically slows down the response time as a result of moving large amounts of data. This slowdown may be unacceptable for certain uses. Additionally, sending data to remote systems can introduce new potential points of vulnerability where data may be leaked. Processing data “on edge” (i.e., on local systems) is faster and can provide better privacy than processing data in the cloud, but such edge processing sacrifices many of the benefits of cloud computing.

Hybrid cloud computing models have been developed in order to gain some of the benefits of both cloud and edge computing. Maximizing the combined benefits of such hybrid cloud computing models presents various technical challenges related to data transmission and processing. Therefore, techniques for optimal hybrid cloud computing are highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for data processing. The method comprises: sending, by a first system, a plurality of data processing requests to a buffer, wherein the buffer is stored in a second system, wherein the second system is remote from the first system; pulling a portion of the plurality of data processing requests from the buffer; processing the portion of the plurality of data processing requests pulled from the buffer in order to obtain at least one data processing result; and sending the at least one data processing result to the buffer.

Certain embodiments disclosed herein also include a non-transitory computer readable medium having stored thereon causing a processing circuitry to execute a process, the process comprising: sending, by a first system, a plurality of data processing requests to a buffer, wherein the buffer is stored in a second system, wherein the second system is remote from the first system; pulling a portion of the plurality of data processing requests from the buffer; processing the portion of the plurality of data processing requests pulled from the buffer in order to obtain at least one data processing result; and sending the at least one data processing result to the buffer.

Certain embodiments disclosed herein also include a system for data processing. The system comprises: a processing circuitry; and a memory, the memory containing instructions that, when executed by the processing circuitry, configure the system to: send a plurality of data processing requests to a buffer, wherein the system is a first system, wherein the buffer is stored in a second system, wherein the second system is remote from the first system; pulling a portion of the plurality of data processing requests from the buffer; processing the portion of the plurality of data processing requests pulled from the buffer in order to obtain at least one data processing result; and sending the at least one data processing result to the buffer.

Certain embodiments disclosed herein include the method, non-transitory computer readable medium, or system noted above or below, wherein another portion of the plurality of data processing requests is processed by at least one third system, wherein each of the at least one third system is remote from the first system.

Certain embodiments disclosed herein include the method, non-transitory computer readable medium, or system noted above or below, wherein the at least one data processing result is at least one first data processing result, wherein the at least one third system is configured to send at least one second data processing result to the buffer.

Certain embodiments disclosed herein include the method, non-transitory computer readable medium, or system noted above or below, wherein each of the plurality of data processing requests is a request for a data processing activity which uses less than a threshold amount of bandwidth.

Certain embodiments disclosed herein include the method, non-transitory computer readable medium, or system noted above or below, wherein the plurality of data processing requests is sent to the buffer based on a distribution of data processing, wherein the distribution of data processing is determined based on at least one of speed and latency.

Certain embodiments disclosed herein include the method, non-transitory computer readable medium, or system noted above or below, wherein the plurality of data processing requests is streamed to the buffer over time.

Certain embodiments disclosed herein include the method, non-transitory computer readable medium, or system noted above or below, wherein the plurality of data processing requests is sent to the buffer using a message queuing service cloud-based communication protocol.

Certain embodiments disclosed herein include the method, non-transitory computer readable medium, or system noted above or below, wherein the at least one data processing result is sent to the buffer using a message publication service cloud-based communication protocol.

Certain embodiments disclosed herein include the method, non-transitory computer readable medium, or system noted above or below, wherein the plurality of data processing requests is sent without opening any ports between the first system and the second system.

Certain embodiments disclosed herein include the method, non-transitory computer readable medium, or system noted above or below, wherein the plurality of data processing requests include requests for processing groups of frames among the video content, wherein each group of frames includes a plurality of frames.

Certain embodiments disclosed herein include the method, non-transitory computer readable medium, or system noted above or below, further including or being configured to perform the following steps: encrypting data to be processed, wherein each of the plurality of data processing requests includes a portion of the encrypted data.

Certain embodiments disclosed herein include the method, non-transitory computer readable medium, or system noted above or below, further including or being configured to perform the following steps: processing, by the first system, a portion of the video content per-frame.

Certain embodiments disclosed herein include the method, non-transitory computer readable medium, or system noted above or below, further including or being configured to perform the following steps: detecting at least one event with respect to the video content based on results of processing the portion of the video content per-frame, wherein the plurality of data requests are sent to the buffer in response to detection of the at least one event.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram illustrating a distributed cloud computing environment which may be utilized in accordance with various disclosed embodiments.

FIG. 2 is a flow diagram illustrating data processing which may be performed in a distributed cloud computing environment according to various disclosed embodiments.

FIG. 3 is a flowchart illustrating a method for edge data processing using a distributed cloud virtual memory architecture according to an embodiment.

FIG. 4 is a flowchart illustrating a method for distributed data processing using portless network communications according to an embodiment.

FIG. 5 is a flowchart illustrating a method for cloud data processing using a distributed cloud virtual memory architecture according to an embodiment.

FIG. 6 is a schematic diagram of a hardware layer which may be utilized in accordance with any of the disclosed embodiments.

### DETAILED DESCRIPTION

In light of the challenges and goals noted above, the disclosed embodiments provide various techniques for distributed computing which leverage hybrid cloud-edge environments in order to optimize distributed computing. In particular, various disclosed embodiments include distributed cloud virtual memory architectures as well as techniques for utilizing such distributed cloud virtual memory architectures. The distributed cloud virtual memory architectures may be realized via a distributed computing environment including one or more cloud networks deployed remotely from one or more edge networks, where each network may include one or more systems, storages, both, and the like.

In an embodiment, data processing activities are distributed between an edge and a cloud based on factors such as resource consumption, capacity, capabilities, combinations thereof, and the like. In a further embodiment, the data processing activities are distributed by utilizing network communications in order to stream data processing requests for discrete portions of the data to be processed to a buffer in the cloud. Requests are written to such a cloud buffer. Once written, the requests may be pulled and processed individually by systems on the edge and systems in the cloud. Results of processing the requests are published to the buffer. This distribution of data processing activities may be performed without opening ports between the edge and the cloud, and may allow for minimizing cloud processing in order to improve data processing performance while retaining access to cloud resources for scalability purposes.

The disclosed embodiments provide various benefits including, but not limited to, improved security, privacy, and scalability. In particular, various disclosed embodiments may be implemented without opening ports between public and private networks by writing requests to buffers in the cloud and publishing results to those buffers via edge devices, thereby improving security by avoiding introducing ports as potential points of vulnerability. Additionally, data such as video may be generally stored on local networks (i.e., not in the cloud or otherwise on remote networks), and only limited data may be streamed over secure connections between edge and cloud devices. This improves privacy by minimizing the network locations in which potentially sensitive data is exposed.

Further, the disclosed embodiments may provide significant savings in bandwidth by reducing traffic by several magnitudes as compared to various existing solutions. In accordance with at least some disclosed embodiments, all high bandwidth activities (i.e., activities which would require greater than a threshold amount of bandwidth in order to transmit data needed for performing such activities) may be performed locally on edge networks. This is particularly beneficial for uses involving video data, in which many existing solutions demonstrate bandwidth consumption which may be over 1000 times reduced as compared to the bandwidth consumption of existing solutions. Reducing the amount of bandwidth consumed further aids in scalability since more iterations of comparable processing may be performed using the same amount of available bandwidth.

Moreover, the disclosed embodiments provide various techniques which allow for overcoming limitations on edge computing by leveraging cloud computing resources. To this end, various disclosed embodiments utilize data in order to make decisions regarding distribution of processing between the cloud and edge. Such data may include, but is not limited to, resource consumption, frequency, availability, and task statuses. The decisions may be performed in order to optimally utilize cloud computing resources in tandem with edge computing resources.

By optimally using cloud computing resources, use of cloud computing resources may be minimized to the minimal amount needed for accomplishing certain data processing tasks. As noted above, use of cloud computing resources can hinder speed and increase latency. Accordingly, minimizing use of cloud computing resources by making decisions regarding distribution of processing between the cloud and edge as described herein allows for improving speed and latency. These improvements may be particularly relevant for implementations in which data processing is required in real-time or otherwise when low latency is required, such as real-time video processing. As a non-limiting example, video monitoring of vehicles may require real-time video processing in order to effectively make decisions based on results of processing in real-time.

Further, some embodiments may support distributed processing implementations in which processing is to be performed using more basic models on edge, and only certain processing is to be performed using more advanced models in the cloud. As a non-limiting example, a student machine learning model may be deployed on edge, where the student model is trained on a subset of a feature domain used by a teacher model. Based on outputs of the student model performed on edge, certain portions of content may be selected for uploading to a teacher model deployed via one or more remote systems to be analyzed further in the cloud. The student model may be a model which requires less processing to apply than the teacher model. The disclosed embodiments may be utilized to further support such a distributed implementation, for example by aiding in making decisions regarding other aspects of processing data related to the content being processed by the student model or by using portless deployment to facilitate transmission of data between the systems implementing the student and teacher models.

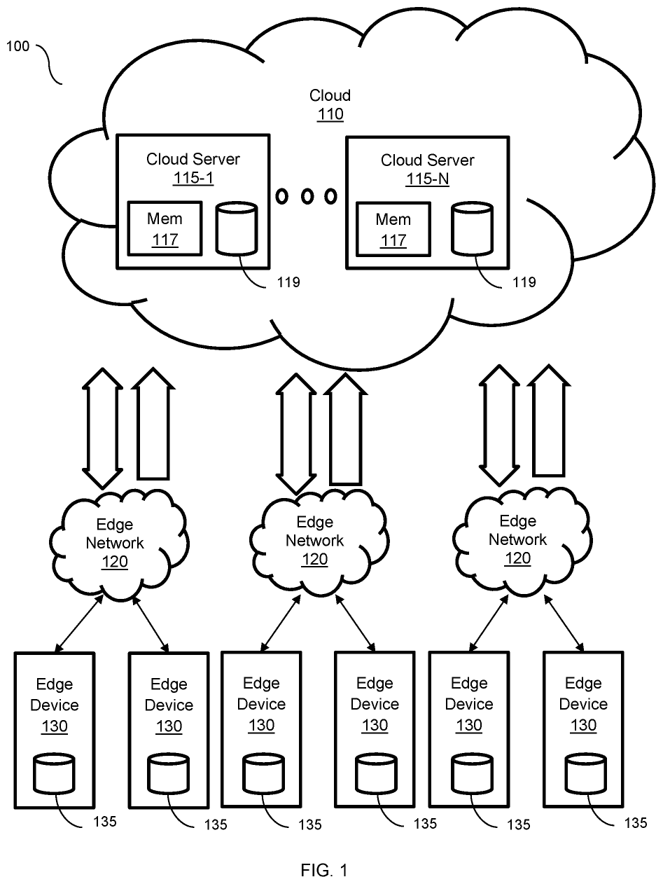

FIG. 1 shows an example network diagram 100 utilized to describe the various disclosed embodiments. In the example network diagram 100, edge devices 130 communicate with one or more cloud servers 115-1 through 115-N (where N is an integer having a value equal to or greater than 1) via a cloud network (“cloud”) 110 and edge networks 120.

Each of the cloud network 110 and the edge network 120 may be, but is not limited to, a wireless, cellular or wired network, a local area network (LAN), a wide area network (WAN), a metro area network (MAN), the Internet, the worldwide web (WWW), similar networks, a combination thereof, a portion thereof, and the like. In an example implementation, the cloud network 110 and the edge network 120 communicate via the Internet (not separately depicted) such that the cloud servers 115 deployed in the cloud network 110 may provide cloud computing services to the edge devices 130 via the Internet.

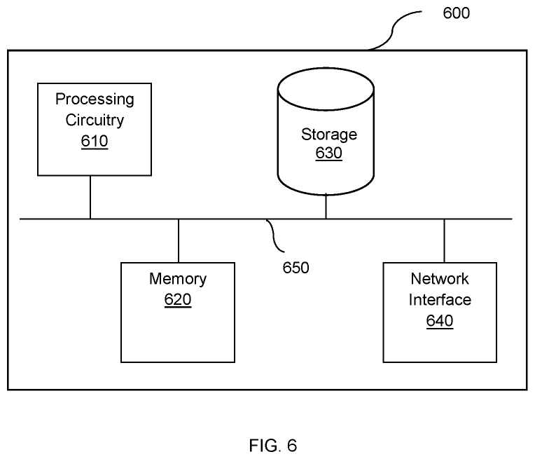

Each of the edge devices 130 and the cloud servers 115 is a computer system configured to perform data processing functions. To this end, non-limiting example hardware which may be utilized by the edge devices 130 and/or the cloud servers 115 is described further below with respect to FIG. 6.

Each of the edge devices 130 is configured to communicate according to one or more cloud-based communication protocols such as, but not limited to, message publication service protocols, message queueing service protocols, both, and the like. In particular, in accordance with various disclosed embodiments, such protocols may allow for utilizing one or more message publication services (e.g., Amazon Simple Notification Service [SNS] or publication of a message to an Apache Kafka topic) and one or more message queueing services (e.g., Amazon Simple Queue Service [SQS] or queueing of messages via a queueing model utilized in Apache Kafka) collectively in order to realize at least a portion of the disclosed embodiments related to storing requests in buffers while pulling requests and publishing results by writing to those buffers.

To further support various disclosed embodiments, the edge devices 130 may be adapted to have various capabilities such as, but not limited to, able to be self-maintained, able to handle errors, able to perform auto-recovery techniques, configured to perform encryption, combinations thereof, and the like. Additionally, any of the edge devices 130 may be configured to perform load balancing, or a separate load balancer (not shown) may be deployed with respect to the edge devices 130 in order balance data processing loads among the edge devices 130.

In accordance with various disclosed embodiments, data processing activities are distributed between the cloud servers 115 and one or more of the edge devices 130 as described herein. To this end, the edge devices 130, the cloud servers 115, or both, may each be configured to perform at least a portion of the disclosed embodiments. In particular, any or all of the edge devices 130, or one or more edge servers (not shown) deployed in any of the edge networks 120, may be configured to write to buffers in the cloud servers 115 as described herein. More specifically, each of the cloud servers 115 may have a memory (Mem) 117, and such a buffer may be stored in one or more of the memories 117 of the cloud servers 115.

To support the disclosed embodiments, each of the cloud servers 115 may further include a storage 119. The storages 119 may store, among other things, results of processing as described herein. In some implementations, at least a portion of the data to be processed may be stored in the storages 119. Each of the edge devices 130 may also have a respective storage 135 which may be utilized to store content for processing as described herein.

In accordance with at least some embodiments, the data to be processed may be stored in buffers among the memories 117, and the edge devices 130, the cloud servers 115, or both, may store requests for data processing, results of data processing, or both, in such a buffer. As described herein, requests and results may be published to such a buffer, and the edge devices 130 may pull requests from the buffer in order to obtain data for edge processing. In this manner, both the edge devices 130 and the cloud servers 115 may access the data such that data processing activities may be distributed between edge and cloud. Further, writing data processing requests to a buffer and reading requests from that buffer allows for performing network communications between the edge devices 130 and the cloud servers 115 without needing to open ports, which reduces potential points of exposure as compared to communications utilizing ports for network communications and therefore improves security of distributed data processing as described herein.

It should be noted that FIG. 1 depicts multiple edge networks 120, each of which is used to communicate with multiple edge devices 130, merely for illustrative purposes, but that at least some of the disclosed embodiments may be equally applied to implementations in which a portion of the data processing is distributed to only a single edge device 130, or to multiple edge devices 130 via a single edge network 120.

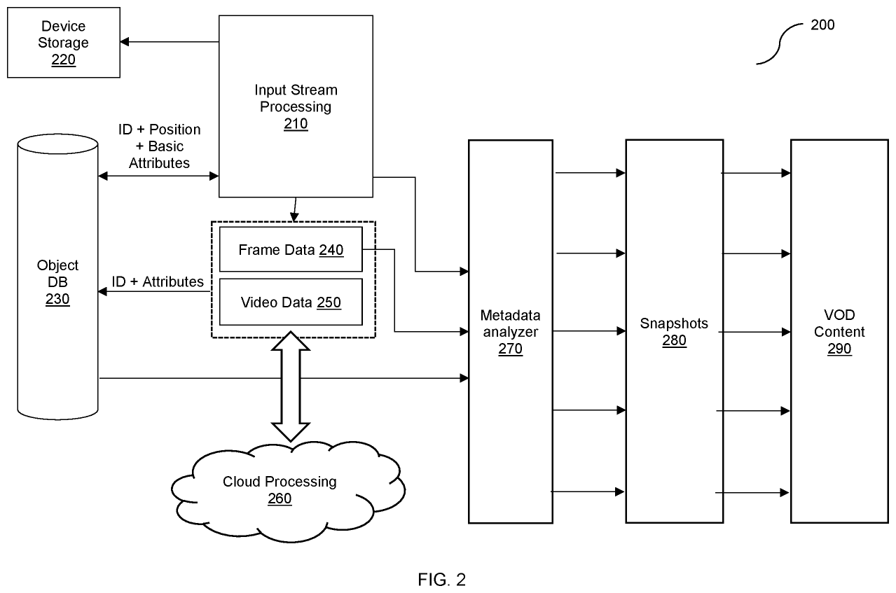

FIG. 2 is a flow diagram 200 illustrating data processing which may be performed in a distributed cloud computing environment according to various disclosed embodiments. The flow diagram 200 illustrates a process which may be performed at least partially on edge, for example, via one or more edge devices (e.g., of the edge devices 130, FIG. 1) communicating via one or more edge networks (e.g., of the edge networks 120, FIG. 1). In accordance with various disclosed embodiments, at least some portions of data to be processed are sent for cloud processing, for example, via one or more cloud servers (e.g., of the cloud servers 115, FIG. 1) communicating via one or more cloud networks (e.g., the cloud network 110, FIG. 1).

As shown in the flow diagram 200, input stream processing 210 is performed in order to process an input stream and to provide at least a portion of results of the input stream processing to one or more device storages 220 and to an object database (DB) 230. The input stream may initially be, for example but not limited to, in clips or other portions delivered according to some recording rate. As a non-limiting example, 1-minute clips may be provided as the input stream and stored in one or more data storage locations of a device.

The input stream processing 220 may include, but is not limited to, performing load balancing, performing initial detection and classification, other initial processing used to aid subsequent processing, combinations thereof, and the like. Moreover, characteristics of the input stream in forms such as identifiers, positions, and basic attributes, may be identified during the input stream processing 220 and utilized for subsequent analyses.

At least a portion of the results of the input stream processing 210 may be further divided into different kinds of data such as, but not limited to, a first set of frame data 240 and a second set of video data 250. In a non-limiting example implementation where the analysis is performed with respect to vehicles shown in video content, the frame data 240 may include per-frame data to be stored on edge, processed on edge, or both, and the video data 250 may include data which is not per-frame to be stored on cloud, processed on cloud, or both. Such not per-frame data may include, but is not limited to, clips or other portions of video content including multiple frames or otherwise is not stored as units of frames.

In various embodiments, the frame data 240 may be provided to a metadata analyzer 270 for further processing on edge, and the video data 250 may be sent for cloud processing 260. To this end, which portions of data to include as the video data 250 for upload to the cloud may be determined based on criteria such as, but not limited to, detection of certain events (e.g., events triggered by certain alerts), which may vary depending on the use case. As a non-limiting example, detection of movement or initial classification of an object in video content as a vehicle may be an event which causes portions of video showing the movement or object to be stored as clips of video data 250 to be uploaded for further processing in the cloud processing 260.

The cloud processing 260 may return results to be provided, for example, to the metadata analyzer 270 for subsequent processing.

The metadata analyzer 270 is configured to analyze data derived from the frame data 240, the video data 250, the cloud processing 260, or a combination thereof, in order to output metadata representing analysis results such as, but not limited to, attributes. As a non-limiting example where the data being processed is visual content such as videos showing vehicles and the attributes to be processed include vehicle attributes, the metadata output by the metadata analyzer 270 may information like a type of car, a license plate number of the car, and the like.

The results of the metadata analyzer 270 may be output and provided to one or more further processes. In the example implementation shown in FIG. 2, the results of the metadata analyzer 270 may be stored as snapshots 280. The snapshots 280 may be or may include thumbnails in forms such as, but not limited to, compressed images such as Joint Photographic Exports Group (JPEG) images, high resolution cropped images (e.g., images having a resolution above a threshold), both, and the like. Moreover, any or all of such thumbnails may be compressed to reduce size.

The snapshots 280, in turn, may be utilized to further mark video on demand (VOD) content 290, e.g., by associating thumbnails with corresponding portions of the VOD content. The results of the metadata analyzer 270, the snapshots 280, the VOD content 290, or a combination thereof, may be provided for subsequent uses such as, but not limited to, being provided as results of data processing, used for training machine learning models (e.g., models used for the cloud processing 260 or for processing the frame data 240), or otherwise used for subsequent processing, the details of which may depend upon the implementation.

It should be noted that various components are FIG. 2 are described as processes, but that at least some of these components may be realized as hardware or software components configured to perform those respective processes. As a non-limiting example, the input stream processing 210 may refer to a part or step of the data processing, and may be realized via a hardware or software component configured to perform input stream processing functions utilized during the input stream processing 210.

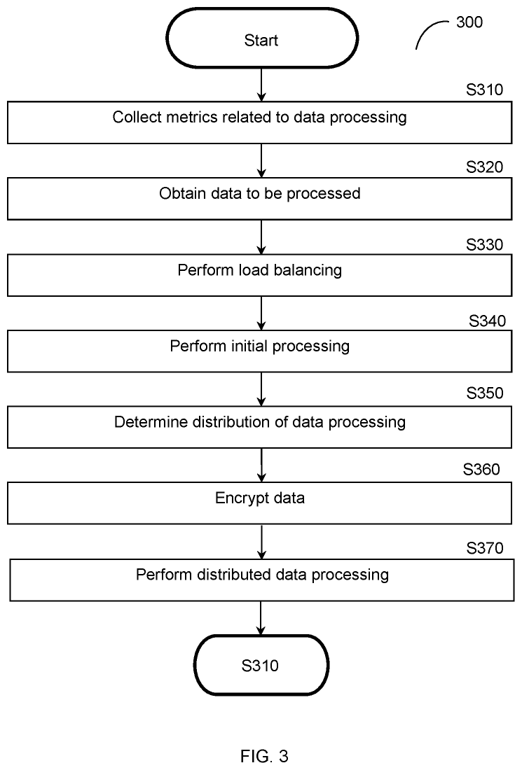

FIG. 3 is a flowchart 300 illustrating a method for edge data processing using a distributed cloud virtual memory architecture according to an embodiment. In an embodiment, the method is performed via one of the edge devices 130, FIG. 1.

At S310, data processing is monitored and metrics related to data processing are collected based on the monitoring. Such metrics include metrics related to resource consumption and frequency of object detection such as, but not limited to, compute status, number of objects found via analysis of content, task statuses (e.g., numbers of tasks at different times), how many units of computing resources are consumed by each process, how frequently processes are performed, combinations thereof, and the like. Such metrics may be analyzed in order to make decisions regarding distribution of data processing, i.e., such that data processing performed in the cloud (e.g., on cloud servers) may be minimized while meeting one or more goals with respect to speed and latency (e.g., goals defined with respect to certain metrics of speed, latency, or a combination thereof).

At S320, data to be processed is obtained. The data to be processed may be received at one or more edge devices (e.g., the edge devices 130, FIG. 1) and may include, but is not limited to, content such as video content. The data processing to be performed may include activities related to, for example, identifying attributes of objects shown in visual content using machine vision techniques.

At S330, load balancing is performed on the data to be processed in order to distribute initial processing activities, for example, among one or more edge devices. The load balancing may be performed based on the collected metrics related to data processing and, more specifically, metrics collected for edge devices or otherwise for devices among which initial processing is to be distributed. It should be noted that, in some implementations, the load balancing may be performed by a separate load balancer component deployed with respect to the edge.

At S340, initial processing of the data is performed. The initial processing may include, but is not limited to, detection, classification, tracking, combinations thereof, and the like, for example as described above with respect to detection & classification 213 and tracker 214, FIG. 2. The initial processing may be performed in order to derive semantic data indicating aspects related to the use case. As a non-limiting example, semantic data indicating the presence or absence of vehicles within video content may be provided in order to support subsequent processing of the video content with respect to any vehicles whose presence were identified within the vehicle content.

At S350, a distribution of further data processing is determined based on the collected metrics. The distribution is among one or more edge devices and one or more cloud networks or, more specifically, one or more cloud servers. As noted above, the distribution may be determined based further on one or more required metrics related to data processing performance such as measured with respect to speed, latency, a combination thereof, and the like. The cloud networks and servers are deployed remotely from the edge devices.

In a further embodiment, S350 may further include applying one or more resource consumption-based processing rules as part of determining the distribution of data processing. As a non-limiting example, such a rule may require that all high bandwidth activities (e.g., activities whose processes historically take on average at least a threshold amount of bandwidth) are performed only on edge. This further reduces computing resource consumption of the distributed processing. As a non-limiting example, streaming video traffic from a standard camera to the cloud may, on average, consume 8 Megabytes/second (MB/s) of bandwidth. As a further non-limiting example, by streaming data only for activities requiring lower bandwidth to transmit to the cloud, the resource consumption of such streaming may be reduced over 1000 times to consume on average around 0.01 MB/s of bandwidth. Moreover, only streaming lower bandwidth activities may further improve speed and latency of cloud data processing.

In some embodiments, the distribution of data processing may be at least partially determined based on events related to video content as discussed above with respect to FIG. 2. Such events may be utilized to determine which portions of video content are to be processed on edge and which portions are to be processed on cloud. In a further embodiment, the portions of the video content to be processed on edge may be or may include individual frames to be processed per-frame on edge, and the portions of the video content to be processed in cloud may be clips or other groups of frames among the video content. When an event is detected, a clip or other group of frames (e.g., a predetermined number of frames or otherwise a clip having a certain length) may be uploaded such that at least a portion of the processing of those groups of frames is performed on cloud, and other individual frames are processed on edge. Moreover, the processing of individual frames on a per-frame basis may be performed on edge in order to determine metadata which may be utilized to detect events, thereby allowing for determining which portions of content should be uploaded as clips or other groups of frames for at least some cloud processing.

As noted above, using cloud resources improves access to compute and storage resources, but faces drawbacks with respect to speed and latency. Distributing computing based on the collected metrics and required performance metrics allows for minimizing use of cloud resources to an amount of user which meets the required metrics while maximizing the access to additional resources which may be needed, for example, based on demand (i.e., how much and what kinds of data are to be processed), frequency of processes, amounts of resources used by different processes, combinations thereof, and the like.

At S360, at least a portion of the data to be processed may be encrypted. In an embodiment where visual content such as video is being processed, at least a portion of that visual content may be encrypted. When encrypted, content uploaded to the cloud as described herein (e.g., content saved in a buffer in one or more cloud servers) is further secured. This further improves security of distributed data processing on top of benefits related to minimizing cloud processing as discussed herein.

At S370, distributed data processing is performed. More specifically, data processing activities performed at S370 are distributed between an edge and a cloud, where the edge includes one or more edge devices (e.g., the edge devices 130, FIG. 1) which may communicate with each other or with remote systems via one or more edge networks (e.g., the edge networks 120). The remote systems may be deployed at another location and accessible to the edge devices over one or more networks such as the Internet. The cloud may include cloud servers (e.g., the cloud servers 115) or other such remote systems, and may be deployed in one or more cloud networks (e.g., the cloud network 110).

As noted above, using cloud computing resources provides access to additional compute and storage capacity, but may worsen performance with respect to speed, latency, and the like. In accordance with various disclosed embodiments, the data processing is distributed between edge and cloud based on performance, capacity, resource consumption, combinations thereof, portions thereof, and the like. Such distribution is performed so as to optimize data processing with respect to, for example, minimizing the amount of data to be processed in cloud while improving scalability of data processing activities.

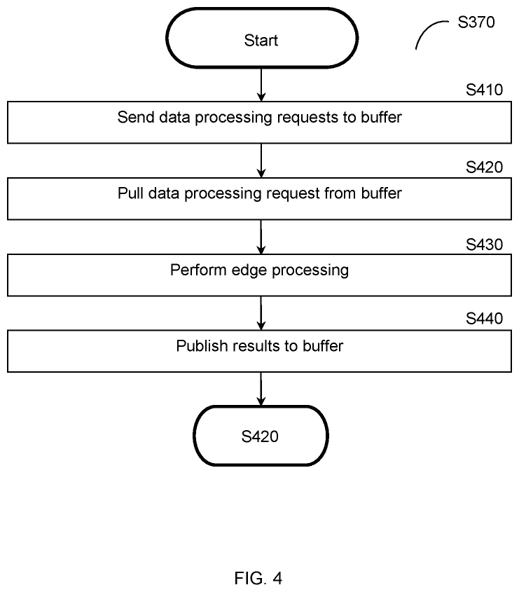

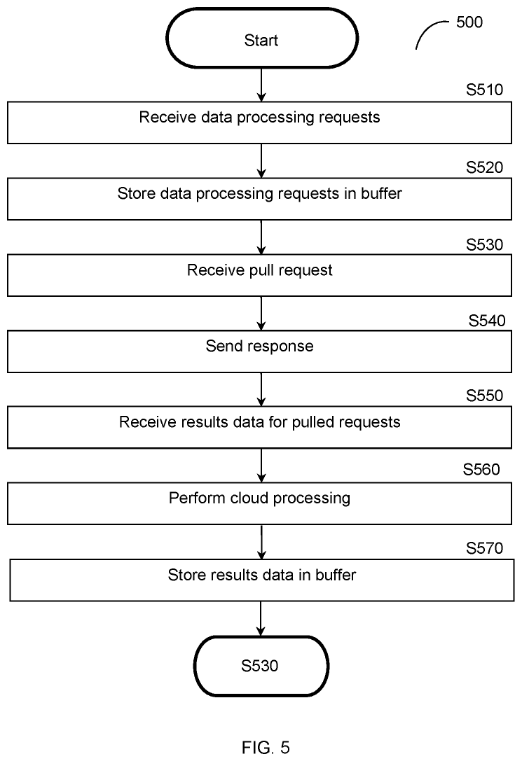

In an embodiment, the distributed data processing is performed at least partially as described with respect to FIG. 4. In particular, in such an embodiment, the distribution of data processing activities is realized via the network communication technique described with respect to FIG. 4 and further elaborated on with respect to FIG. 5. Such a network communication technique may be portless, i.e., may be realized without opening additional ports between the system sending the data processing requests (e.g., an edge device) and the system to which the data processing requests are sent (e.g., a cloud server configured to store received requests in the buffer).

More specifically, as described herein, such a portless network communication technique may include storing requests for data processing and results of processing data according to those requests in a buffer (e.g., a buffer deployed in the cloud) which is accessible to systems which are remote from each other (e.g., a buffer which is accessible both to devices deployed on edge and to servers deployed on cloud). In this manner, data to be processed locally (e.g., on edge) may be stored locally, and only data which might be processed remotely (e.g., in the cloud) may be streamed to remote systems over a secured streaming connection. Such streaming may include sending a sequence of data elements to be processed separately over time rather than in batches so as to minimize the exposure of larger portions of data at any given time. As a non-limiting example, clips, frames, or other portions of videos may be streamed and processed individually in the cloud rather than uploading an entire video to the cloud at once.

In this regard, it has been identified that public networks providing additional cloud computing resources (e.g., cloud networks) are by default accessible to other systems in private networks for use in distributing computing activities. It has further been identified that, as a result of this property, traffic control systems such as firewalls may be maintained while transferring data between private and public networks without opening ports. Further using cloud-based communication protocols such as message publication services (e.g., SNS) and message queueing services (e.g., SQS) allows for storing requests in buffers while pulling requests and publishing results by writing to those buffers, which in turn allows for transmitting data to be processed as part of such requests without requiring opening additional ports.

FIG. 4 is a flowchart S370 illustrating a method for distributed data processing using portless network communications according to an embodiment.

At S410, data processing requests are sent to a buffer. In an embodiment, the data processing requests may be sent using a cloud-based communication protocol for a message queueing service (e.g., SQS). Messages sent to a buffer in this manner may not be pushed to recipients, rather, they may be pulled by systems (e.g., a system selected to perform a specific portion of data processing activities). Moreover, as noted above, in some embodiments, only portions of data to be processed in activities requiring high bandwidth or otherwise requiring over a threshold amount of network-related computer resources to transmit are sent to the buffer.

In some embodiments, S410 may further include subscribing to a subscription service of a publication system utilizing the buffer. Such a subscription service may push messages including certain data to devices or systems which are subscribed to the service. In a further embodiment, devices or systems subscribed to the service may receive pushed messages including results of data processing activities which are published to the buffer.

In an embodiment, the buffer is a region of memory used to temporarily store data. The buffer may be realized as a memory location in hardware, or as a virtual data buffer in software pointing to a location in physical memory. The buffer may be deployed remotely from the system performing the method of FIG. 4. As a non-limiting example, the buffer may be stored in a memory of one of the cloud servers 115 when the method of FIG. 4 is performed by one of the edge devices 130. It should also be noted that the buffer may be a distributed buffer distributed across multiple memories or otherwise distributed across multiple locations.

At S420, a data processing request is pulled from the buffer. In an embodiment, pulling the requests includes sending pull requests to the server or other system configured to access the buffer (e.g., one of the cloud servers 115, FIG. 1). To this end, the buffered data processing requests may be a set of first requests, and S420 may include sending one or more second requests, where the second requests are pull requests for retrieval of one or more of the data processing requests. The response to such a pull request may be or may include one or more of the buffered data processing requests. In a further embodiment, the data processing requests may be pulled continuously while data processing activities are being performed.

At S430, edge processing is performed on the pulled requests. The edge processing may include data processing activities related to the use case such as, but not limited to, metadata analysis of content as discussed above.

As noted above, in accordance with various disclosed embodiments, processing may be distributed between edge and cloud. To this end, S430 includes some data processing activities being performed on edge. Simultaneously or otherwise separately from such edge processing, cloud processing may be performed by cloud devices based on requests stored in the buffer. To this end, in an embodiment, cloud servers or other systems performing such cloud processing pull requests from the same buffer as the edge devices performing the edge processing. In other words, the buffer acts as a common source of data processing requests from which systems deployed remotely to each other can both pull requests to be processed in order to effectively distribute data processing activities between and among those systems.

At S440, results of the edge processing are published to the buffer. In an embodiment, S440 may include publishing such results using a cloud-based communication protocol for a message publication service (e.g., SNS). In various embodiments, execution may continue with S420 where additional data processing requests are pulled from the buffer for processing. Such iterative pulling, processing, and publishing may be performed until data processing activities to be performed by the system are completed.

It should be noted that FIG. 4 is depicted as a flow in a particular order, but that the disclosed embodiments are not limited to the flow depicted in FIG. 4. In particular, any of the steps S420 through S440 may be performed in parallel, or multiple instances of any of those steps may be performed in parallel (e.g., multiple requests may be pulled from the buffer and processed in parallel), without departing from the scope of the disclosure.

FIG. 5 is a flowchart 500 illustrating a method for cloud data processing using a distributed cloud virtual memory architecture according to an embodiment. In an embodiment, the method is performed via one of the cloud servers 115, FIG. 1.

At S510, data processing requests are received, for example, from one or more edge devices deployed at the edge. The data processing requests are requests to process respective portions of data and may include, but are not limited to, respective discrete data elements to be processed. As noted above, such requests may be sent using network communication protocols of a message queuing service.

In some embodiments, the data processing requests may be received along with data indicating the distribution of data processing activities. Such a distribution may be utilized in order to determine how to distribute the data processing activities, for example among cloud servers in the cloud. As noted above, the distribution may be determined so as to minimize use of cloud resources while scaling up to meet one or more performance conditions.

At S520, the data processing requests are stored in a buffer. In an embodiment, the requests may be queued in the buffer.

At S530, a pull request is received. For example, the pull request may be received from one of the edge devices 130, FIG. 1. The pull request is a request to retrieve and provide one or more data processing requests in the buffer.

At S540, a response is sent to the pull request. The response may include, but is not limited to, one or more of the data processing requests stored in the buffer. To this end, S540 includes accessing the buffer in order to retrieve such data processing requests. The retrieved data processing request may be the next request in a queue of the buffer.

At S550, results data is received for the pulled data processing requests sent in response to the pull request at S540. The results data may be published to the buffer using a cloud-based communication protocol for a message publication service (e.g., SNS).

At S560, cloud processing is performed for at least some of the data processing requests stored in the buffer. To this end, S560 may include accessing the buffer and retrieving the next data processing request or requests in the buffer. The number of data processing requests which are processed at S560 depends on the distribution of data processing activities.

At S570, results data is stored in the buffer. The results data may include, but is not limited to, the results data received at S550, the results of the cloud processing, or both. The results data may be published such that it is pushed to systems which are subscribed to a subscription service for the buffer. Alternatively or in combination, the results data may be sent (e.g., to an edge device) for subsequent use.

It should be noted that FIG. 5 is depicted as a flow in a particular order, but that the disclosed embodiments are not limited to the flow depicted in FIG. 5. In particular, any of the steps S530 through S570 may be performed in parallel, or multiple instances of any of those steps may be performed in parallel (e.g., multiple requests may be pulled from the buffer and processed in parallel), without departing from the scope of the disclosure. Also, step S560 may be performed before any or all of steps S530 through S550 without departing from the scope of the disclosure.

It should be noted that the methods of FIGS. 3-4 are discussed from the perspective of the edge and, specifically, with respect to performing those methods via one of the edge devices 130, merely for simplicity. A person of ordinary skill in the art would readily understand that the steps of FIGS. 3-4 may be distributed among multiple edge devices or other systems deployed with respect to the edge, with each edge device performing a portion of any or all steps. Likewise, the method of FIG. 5 may be distributed among multiple cloud servers or other systems deployed in the cloud, with each cloud server performing a portion of any or all steps, without departing from the scope of the disclosed embodiments.

FIG. 6 is an example schematic diagram of a hardware layer 600 which may be utilized in accordance with various disclosed embodiments. The hardware layer 600 may be, but is not limited to, a hardware layer utilized by any or all of the edge devices 130, any or all of the cloud servers 115, or both, and may be utilized by those devices or servers to realize any of the disclosed embodiments. The hardware layer 500 includes a processing circuitry 610 coupled to a memory 620, a storage 630, and a network interface 640. In an embodiment, the components of the hardware layer 500 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the system including the hardware layer 500 to communicate with, for example, the cloud network 110, any or all of the cloud servers 115, any or all of the edge networks 120, any or all of the edge devices 130, combinations thereof, and the like.

It should be understood that the embodiments described herein are not limited to the specific architecture illustrated in FIG. 6, and other architectures may be equally used without departing from the scope of the disclosed embodiments.

It should be noted that various disclosed embodiments are described with respect to the non-limiting example of analyzing video content for vehicles and attributes thereof, but that at least some disclosed embodiments are equally applicable to other implementations including other kinds of content and other types of subjects.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for data processing, comprising:
sending, by a first system, a plurality of data processing requests to a buffer, wherein the buffer is stored in a second system, wherein the second system is remote from the first system;
pulling a portion of the plurality of data processing requests from the buffer;
processing the portion of the plurality of data processing requests pulled from the buffer in order to obtain at least one data processing result; and
sending the at least one data processing result to the buffer.

2. The method of claim 1, wherein another portion of the plurality of data processing requests is processed by at least one third system, wherein each of the at least one third system is remote from the first system.

3. The method of claim 2, wherein the at least one data processing result is at least one first data processing result, wherein the at least one third system is configured to send at least one second data processing result to the buffer.

4. The method of claim 1, wherein each of the plurality of data processing requests is a request for a data processing activity which uses less than a threshold amount of bandwidth.

5. The method of claim 1, wherein the plurality of data processing requests is sent to the buffer based on a distribution of data processing, wherein the distribution of data processing is determined based on at least one of speed and latency.

6. The method of claim 1, further comprising:
encrypting data to be processed, wherein each of the plurality of data processing requests includes a portion of the encrypted data.

7. The method of claim 1, wherein the plurality of data processing requests is streamed to the buffer over time.

8. The method of claim 1, wherein the plurality of data processing requests is sent to the buffer using a message queuing service cloud-based communication protocol.

9. The method of claim 1, wherein the at least one data processing result is sent to the buffer using a message publication service cloud-based communication protocol.

10. The method of claim 1, wherein the plurality of data processing requests is sent without opening any ports between the first system and the second system.

11. The method of claim 1, wherein the plurality of data processing requests include requests for processing groups of frames among the video content, wherein each group of frames includes a plurality of frames.

12. The method of claim 11, further comprising:
processing, by the first system, a portion of the video content per-frame.

13. The method of claim 12, further comprising:
detecting at least one event with respect to the video content based on results of processing the portion of the video content per-frame, wherein the plurality of data requests are sent to the buffer in response to detection of the at least one event.

14. A non-transitory computer readable medium having stored thereon instructions for causing a processing circuitry to execute a process, the process comprising:
sending, by a first system, a plurality of data processing requests to a buffer, wherein the buffer is stored in a second system, wherein the second system is remote from the first system;
pulling a portion of the plurality of data processing requests from the buffer;
processing the portion of the plurality of data processing requests pulled from the buffer in order to obtain at least one data processing result; and
sending the at least one data processing result to the buffer.

15. A system for processing data, comprising:
a processing circuitry; and
a memory, the memory containing instructions that, when executed by the processing circuitry, configure the system to:
send, by a first system, a plurality of data processing requests to a buffer, wherein the buffer is stored in a second system, wherein the second system is remote from the first system;
pull a portion of the plurality of data processing requests from the buffer;
process the portion of the plurality of data processing requests pulled from the buffer in order to obtain at least one data processing result; and
send the at least one data processing result to the buffer.

16. The system of claim 15, wherein another portion of the plurality of data processing requests is processed by at least one third system, wherein each of the at least one third system is remote from the first system.

17. The system of claim 16, wherein the at least one data processing result is at least one first data processing result, wherein the at least one third system is configured to send at least one second data processing result to the buffer.

18. The system of claim 15, wherein each of the plurality of data processing requests is a request for a data processing activity which uses less than a threshold amount of bandwidth.

19. The system of claim 15, wherein the plurality of data processing requests is sent to the buffer based on a distribution of data processing, wherein the distribution of data processing is determined based on at least one of speed and latency.

20. The system of claim 15, further comprising:
encrypt data to be processed, wherein each of the plurality of data processing requests includes a portion of the encrypted data.

21. The system of claim 15, wherein the plurality of data processing requests is streamed to the buffer over time.

22. The system of claim 15, wherein the plurality of data processing requests is sent to the buffer using a message queuing service cloud-based communication protocol.

23. The system of claim 15, wherein the at least one data processing result is sent to the buffer using a message publication service cloud-based communication protocol.

24. The system of claim 15, wherein the plurality of data processing requests is sent without opening any ports between the first system and the second system.

25. The system of claim 15, wherein the plurality of data processing requests include requests for processing groups of frames among the video content, wherein each group of frames includes a plurality of frames.

26. The system of claim 25, wherein the system is further configured to:
process, by the first system, a portion of the video content per-frame.

27. The system of claim 26, wherein the system is further configured to:
detect at least one event with respect to the video content based on results of processing the portion of the video content per-frame, wherein the plurality of data requests are sent to the buffer in response to detection of the at least one event.
